(19) United States
(12) Patent Application Publication
(10) Pub. No.: US 2015/0381434 A1
(43) Pub. Date: Dec. 31, 2015

(54) COLOR CODED INTERFACE TO VISUALIZE RADIO FREQUENCY ISSUES ON A FLOOR PLAN

(71) Applicant: Aruba Networks Inc., Sunnyvale, CA (US)

(72) Inventors: Haritha Tamvada, San Jose, CA (US); Joe Heyming, San Jose, CA (US); Sujatha Mandava, Sunnyvale, CA (US)

(73) Assignee: ARUBA NETWORKS INC., Sunnyvale, CA (US)

(21) Appl. No.: 14/319,001

(22) Filed: Jun. 30, 2014

(51) Int. Cl. H04L 12/24; H04L 12/26; G06F 3/0484; G06F 3/0481; G06F 3/0482

(52) U.S. Cl. CPC H04L 41/22; G06F 3/04817; G06F 3/0482; G06F 3/04842; H04L 43/08

(57) ABSTRACT

A non-transitory computer readable medium includes instructions which, when executed by one or more hardware processors, cause performance of obtaining a performance measurement and a physical location for client devices, generating visual representations corresponding to the client devices by: for each client device generating a corresponding visual representation based on a respective performance measurement for that client device, and displaying a map of a physical environment with the visual representations, with each visual representation displayed on a location in the map that corresponds to a location of the corresponding client device.

### BACKGROUND

Wireless network diagnosis often require determination if the RF (Radio Frequency) issues for a given device are caused by an AP (access point) via which the device accesses the wireless network, the floor plan where the AP and the device are located, or the device itself. In particular, the floor plan is a drawing that shows relationships between physical features of a space or environment, such as devices and APs located on one level of an office building.

A helpdesk is a resource intended to provide users with information and support related to products and/or services used by the users. The purpose of a helpdesk is usually to troubleshoot problems or provide guidance about products such as computers, electronic equipment, or software, and/or services associated therewith.

### Overview

In general, in one aspect, the invention relates to a non-transitory computer readable medium. The computer readable medium comprising instructions which, when executed by one or more hardware processors, causes performance of: obtaining a performance measurement and a physical location for each of a plurality of client devices; generating a plurality of visual representations corresponding to the plurality of client devices by: for each client device, of the plurality of client devices, generating a corresponding visual representation based on a respective performance measurement for that client device; and displaying a map of a physical environment with the plurality of visual representations, wherein each visual representation is displayed on a location in the map that corresponds to a location of the corresponding client device.

In general, in one aspect, the invention relates to a non-transitory computer readable medium. The computer readable medium comprising instructions which, when executed by one or more hardware processors, causes performance of: receiving a request for a performance measurement of a particular client device of a plurality of client devices; identifying an access point with which the particular client device is associated; identifying a plurality of client devices associated with the access point; displaying a performance measurement for each of the plurality of client devices including the particular client device.

In general, in one aspect, the invention relates to a non-transitory computer readable medium. The computer readable medium comprising instructions which, when executed by one or more hardware processors, causes performance of: obtaining data indicating usage of one or more applications by each of a plurality of client devices; generating a plurality of visual representations corresponding to the plurality of client devices by: for each client device, of the plurality of client devices, generating a corresponding visual representation based on the usage of the one or more applications by the client device; displaying a map of a physical environment with the plurality of visual representation, wherein each visual representation is displayed on a location in the map that corresponds to a location of a corresponding client device.

Other aspects will be apparent from the following description and the appended claims.

### BRIEF DESCRIPTION OF DRAWINGS

FIG. 1 shows a system in accordance with one or more embodiments.

FIG. 2 shows a flow chart of a method in accordance with one or more embodiments.

FIGS. 3.1-3.4 show examples in accordance with one or more embodiments.

FIG. 4 shows a computer system in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding. However, it will be apparent to one of ordinary skill in the art that embodiments may be practiced without these specific details. In other instances, well-known features have not been described in detail to avoid unnecessarily complicating the description.

In general, embodiments provide a non-transitory computer readable medium as well as a system or method for using a color coded interface to visualize RF performance of client devices located on a floor plan. Specifically, embodiments may be used to provide a helpdesk view for a helpdesk user to visualize a specific client device's performance and compare it to other client device's performance on the same AP. For example, the helpdesk view may include a color coded interface to facilitate visualization by the helpdesk user. In one or more embodiments, a performance measure is a measure of actual performance of a client device compared to a target performance of the client device. In particular, the target performance refers to a level of performance expected from the client device without compromise. In one or more embodiments, the performance measure is the ratio of actual airtime spent by the client device transmitting a certain amount of data to a target airtime (also referred to as the ideal airtime) expressed as a percentage (0-100%). This takes into account different client metrics such as dropped packets, retransmissions etc. In one or more embodiments, the performance measure may be based on additional metrics, such as Signal-To-Noise ratio, interferences, retries, etc. and may be referred to as “health,” “RF health,” or “client health.”

Based on the helpdesk view, the RF issues may be attributed to a specific client device or to the radio/AP that the specific client device is connected to. In one or more embodiments, the color coded interface is extended to allow visualization of other metrics, such as application usage. For example, a client device consuming high bandwidth for a given application may be clearly identified in the color coded interface.

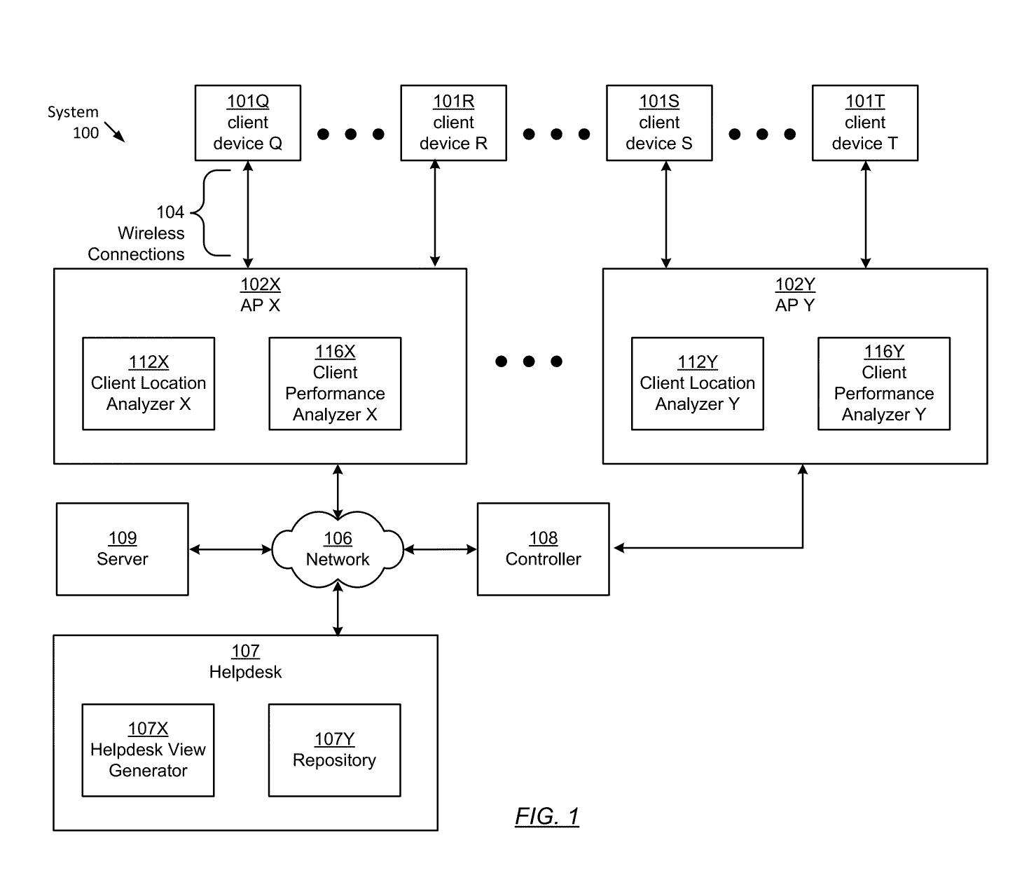

FIG. 1 shows a schematic diagram of a system (100) in accordance with one or more embodiments. As shown in FIG. 1, the system includes client devices (e.g., client device Q (101Q), client device R (101R), client device S (101S), client device T (101T)), APs (e.g., AP X (102X), AP Y (102Y)), a network (106), a controller (108), and a server (109). In one or more embodiments, the client devices and the APs are located in a physical environment (e.g., a floor of an office building) represented by a floor plan. Each of these components is discussed below in accordance with one or more embodiments.

In one or more embodiments, a client device (e.g., client device Q (101Q), client device R (101R), client device S (101S), client device T (101T)) is a hardware component that receives a service from the server (109) or other resources via the network (106). In one or more embodiments, a client device (e.g., client device Q (101Q), client device R (101R), client device S (101S), client device T (101T)) may be one or more mobile devices (e.g., laptop computer, smart phone, personal digital assistant, tablet computer, or other mobile device), gaming console, desktop computers, servers, blades in a server chassis, or any other type of electronic device or devices that includes at least the minimum processing power, memory, and input and output device(s) to perform one or more embodiments. For example, the device may include one or more hardware processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The hardware processor(s) may be an integrated circuit for processing instructions. For example, the hardware processor(s) may be one or more cores, or micro-cores of a processor. The device may also include one or more input device(s), such as: a touchscreen, keyboard, mouse, microphone, touchpad, electronic pen, or any other type of input device. Further, the device may include one or more output device(s), such as: a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The input and output device(s) may be locally or remotely (e.g., via the network) connected to the hardware processor(s), memory, and storage device(s). Many different types of devices exist, and the aforementioned input and output device(s) may take other forms.

The client device may be connected to a network (106) via a network interface connection (not shown) and an AP (e.g., AP X (102X), AP Y (102Y)). The network (106) may be a local area network (LAN), a wide area network (WAN) such as the Internet, mobile network, or any other type of network, or a combination of networks. The client device that connects to the network (106) via a particular AP is referred to as connected to the AP. Typically, the client device may be within wireless signal range of multiple APs but connects to a single AP at any particular time.

An AP (e.g., AP X (102X), AP Y (102Y)) is a digital hardware device that may be communicatively coupled to the network (106). The AP (e.g., AP X (102X), AP Y (102Y)) is a separate hardware unit from a client device (e.g., client device Q (101Q), client device R (101R), client device S (101S), client device T (101T)), that is directly, wired or wirelessly, connected to the client device and is in a communication path from the client device to the network. In other words, the AP may be directly connected via the direct wired/wireless connection (104) to a network interface card on the client device (e.g., client device Q (101Q), client device R (101R), client device S (101S), client device T (101T)). The APs include functionality to transmit and receive packets (discussed below) via the network (106) and wireless connection (104). By way of an example, the AP may include a wireless AP (WAP) that communicates wirelessly with client devices using Wi-Fi, Bluetooth or related standards. Further, APs may be directly connected to the network (106) or connected via a controller (e.g., controller (108)). For example, the controller (108) is a digital hardware device that manages aspects (e.g., sharing and storage of state information) of one or more APs connected to the controller (108).

Each AP may be connected to any number of client devices at any moment in time. Specifically, each AP may be connected to no client devices, a single client device, or multiple client devices at any particular moment in time. Further, the number of client devices connected to an AP may be heterogeneous amongst APs.

In one or more embodiments, an AP (e.g., AP X (102X), AP Y (102Y)) includes a client location analyzer (e.g., client location analyzer X (112x), client location analyzer Y (112y)) and a client performance analyzer (e.g., client performance analyzer X (116x), client performance analyzer Y (116y)). Although not explicitly shown, each AP may also includes one or more hardware processors and memory storing software instructions to perform the functionalities of the client location analyzer and client performance analyzer. For example, the client performance analyzer X (116x) collects performance measurements of one or more client devices (e.g., client device Q (101Q), client device R (101R)) connected to AP X (102X)). In particular, the performance measure may be based on a measurement performed by the AP or obtained from the client device. In one or more embodiments, the performance measurement represents one or more of actual time (referred to as airtime) taken by client device to transmit certain amount of data, Signal-To-Noise (S/N) ratio, interference level, retry rate, drop packet rate, a radio frequency band (e.g., by line), network phone call quality for a client device, application/Lync call quality, etc. In one or more embodiments, the performance measure is normalized, e.g., as: a ratio based on comparison of actual airtime to target airtime, actual S/N ratio to target S/N ratio, actual interference level to target interference level, actual retry rate to target retry rate, actual drop packet rate to target drop rate, actual radio frequency band to target frequency band, actual call quality to a target call quality, actual application/Lync call quality to target application/Lync call quality, etc. In one or more embodiments, the client device performance measures are indexed by client device identifiers and provided to the helpdesk (107).

In one or more embodiments, client location analyzers (e.g., client location analyzer X (112x), client location analyzer Y (112y)) in multiple APs collectively collect information (e.g., signal strength associated with each client device) to determine the locations of the client devices. In one or more embodiments, determining a location for a client device is based on information from the AP to which the client device is connected. The determination of the location may also be made based on information from other APs within range of the client device. In one or more embodiments, APs may share collected information (such as signal strength) among their client location analyzers. The client location analyzers may then use the information from multiple APs in order to determine the location of each client device. The client location analyzers may also provide the information from multiple APs to a central client location analyzer to determine the location of each client device. The central client location analyzer may be one of the client location analyzers included in the APs or located on other network nodes, such as located on a controller (e.g., controller (108)) or the computer server (109). In one or more embodiments, the client device locations are indexed by client device identifiers and provided to the helpdesk (107).

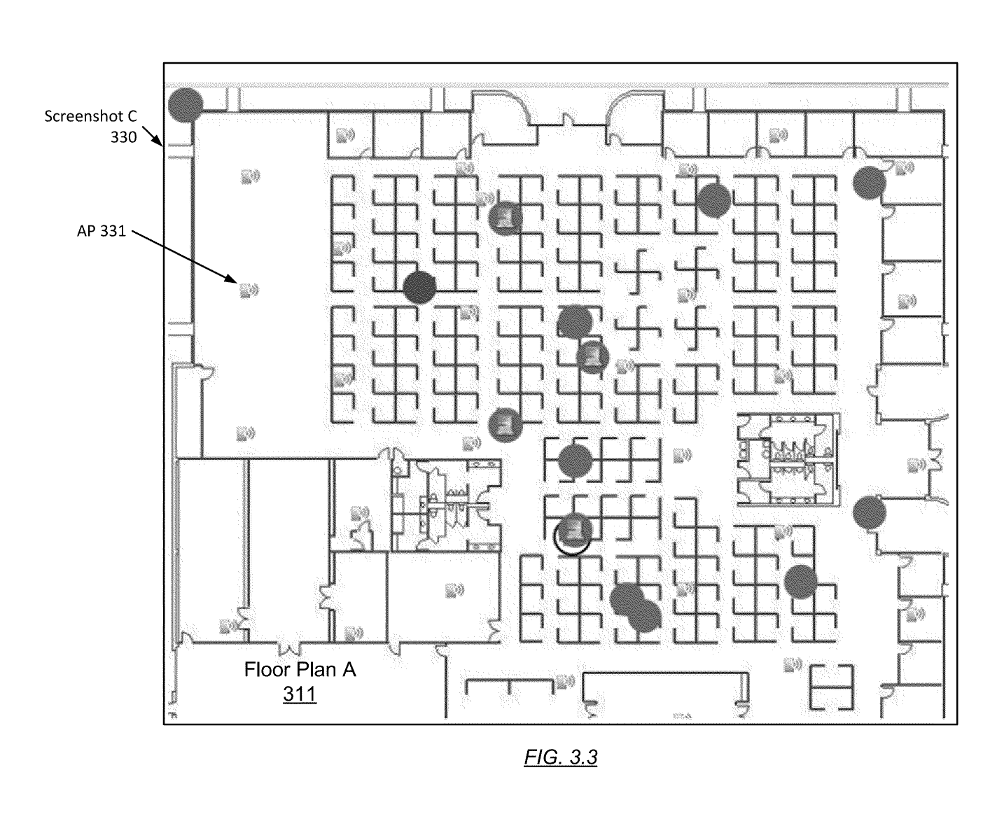

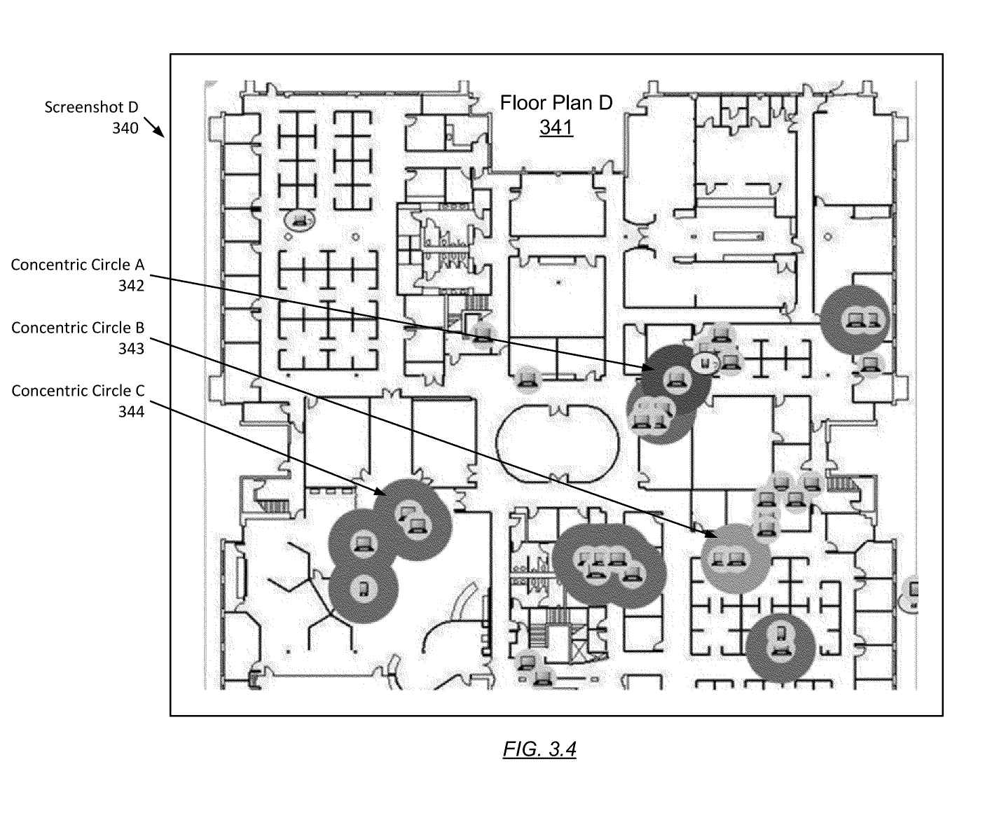

Continuing with FIG. 1, the helpdesk (107) includes a helpdesk view generator (107x) and a repository (107y). In one or more embodiments, the repository (106y) stores the client device locations and client device performance measures that are obtained from the APs or otherwise generated based on information obtained from the APs. In one or more embodiments, the helpdesk view generator (107x) generates a helpdesk view as part of a graphical user interface of the helpdesk (107). Specifically, the helpdesk view presents a floor plan to a user of the helpdesk (107) to visualize performance measures of the client devices. Examples of the floor plan are described in reference to FIGS. 3.1-3.4 below. Although shown as separated from the server (109), in one or more embodiments, the helpdesk (107) may be integrated with the server (109).

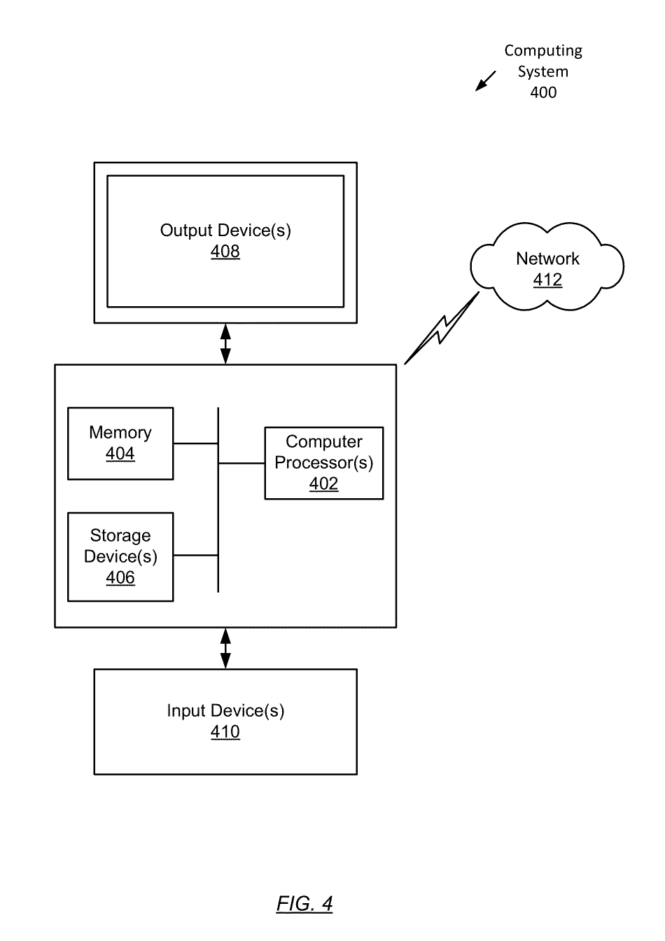

In one or more embodiments, each of the helpdesk (107), the controller (108), and the server (109) may correspond to a computing system or execute on a computing system and cause the computing system to perform the functionalities of the helpdesk (107), the controller (108), or the server (109). An example of the computing system is described in reference to FIG. 4 below.

While FIG. 1 shows a configuration of components, other configurations may be used without departing from the scope of the claims. For example, various components may be combined to create a single component. As another example, the functionality performed by a single component may be performed by two or more components.

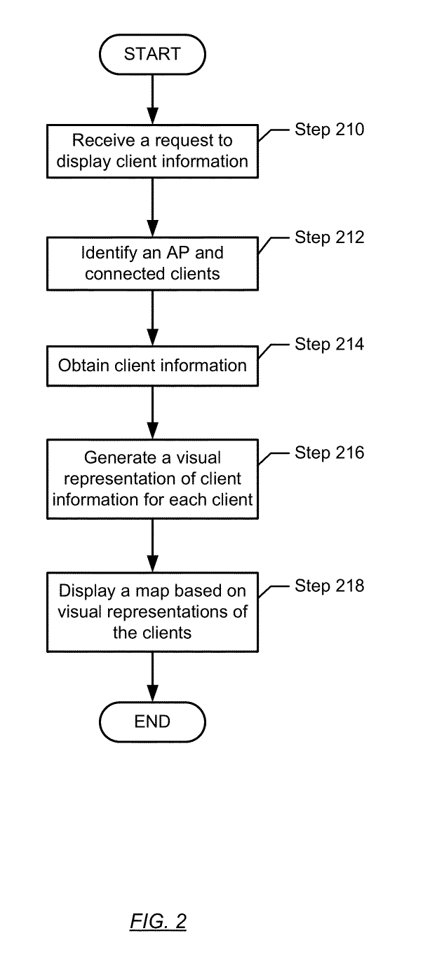

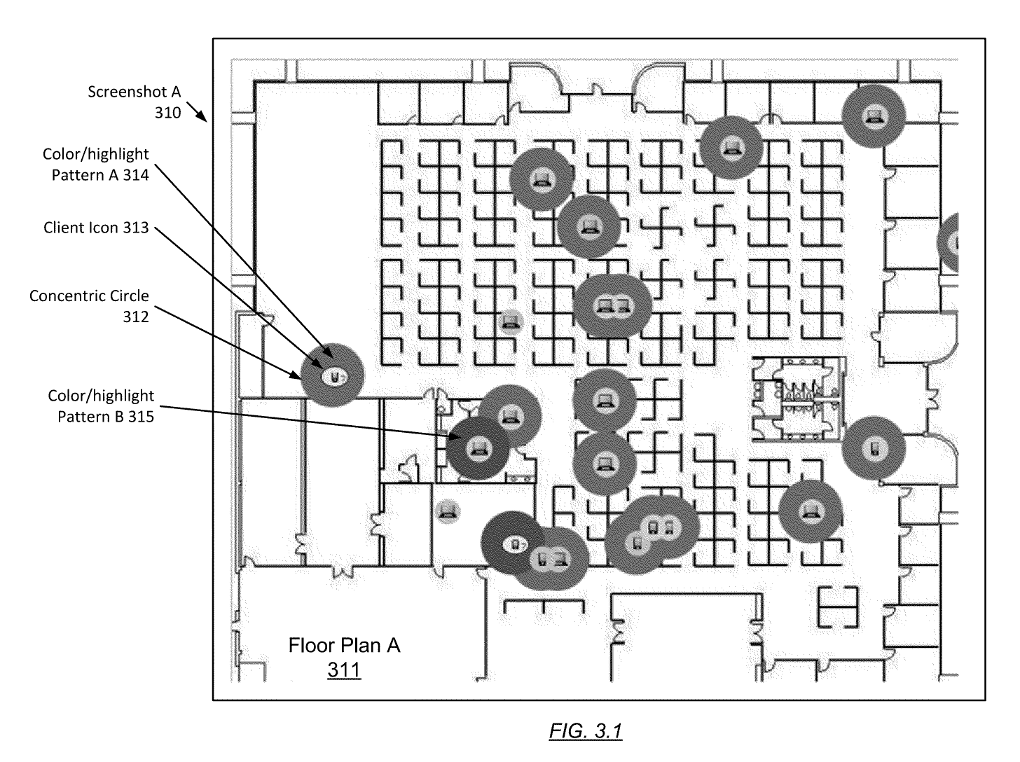

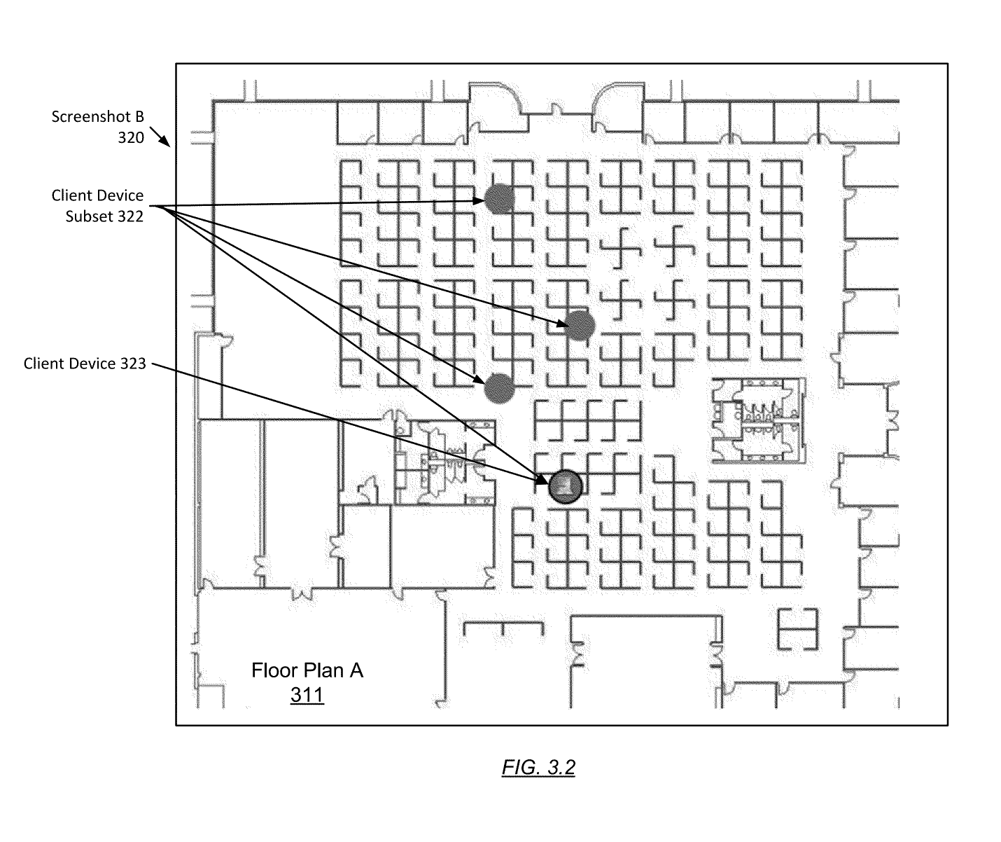

FIG. 2 shows a method flow chart in accordance with one or more embodiments of the invention. In one or more embodiments of the invention, the method of FIG. 2 may be practiced using the system (100) described in reference to FIG. 1 above. In one or more embodiments of the invention, one or more of the steps shown in FIG. 2 may be omitted, repeated, and/or performed in a different order than that shown in FIG. 2. Accordingly, the specific arrangement of steps shown in FIG. 2 should not be construed as limiting the scope of the invention.

Initially in Step 210, a request to display a performance measurement of one or more client devices is received. In one or more embodiments, a set of client devices are located in a physical environment represented by a floor plan. For example, the set of client devices connect to a network via a set of access points (APs) also located in the physical environment. These client devices and APs are said to be located on the floor plan. In one or more embodiments, the request is received by identifying a particular client device among the set of client devices. For example, the particular client device may be identified by a helpdesk user clicking on one of the client icons displayed on the floor plan. An example of requesting to display client performance measurement by identifying a particular client device is described in reference to FIGS. 3.1 and 3.2 below. In one or more embodiments, the request is received by identifying a particular AP of the set of APs. For example, the particular AP may be identified by the helpdesk user clicking on one of the AP icons displayed on the floor plan. An example of requesting to display client performance measurement by identifying a particular AP is described in reference to FIGS. 3.1 and 3.3 below.

In Step 212, an access point (AP) and associated client devices are identified. In one or more embodiments where the request received in Step 210 is by identifying the particular client device, the AP that connects the particular client device to the network is subsequently identified. Accordingly, other client devices connected to the network via the same AP are then identified.

In one or more embodiments where the request received in Step 210 is by identifying the particular AP, all client devices connected to the network via the particular AP are subsequently identified.

In one or more embodiments, the AP and associated client devices are identified based on the Simple Network Management Protocol (SNMP).

In Step 214, the performance measurement and a physical location are obtained for each of the client devices identified in Step 212 above. In one or more embodiments, the performance measurement and the physical location are obtained using functionalities of the APs described in reference to FIG. 1 above.

In Step 216, visual representations corresponding to the client devices are generated. In one or more embodiments, for each client device, a corresponding visual representation is generated based on a respective performance measurement for that client device. In one or more embodiments, for each client device, a corresponding visual representation is generated based on a respective application usage for that client device. In one or more embodiments, the generated visual representations correspond to a subset of all client devices located on the floor plan. In particular, the subset of client devices are identified by the Steps 210 and 212 above. In one or more embodiments, the generated visual representations correspond to all client devices located on the floor plan. For example, a visual representation is generated for each client device regardless whether the client device is within the subset of client devices identified by the Steps 210 and 212 or not. In another example, the Steps 210 and 212 described above are omitted and therefore no client device is skipped in generating its visual representation.

In Step 218, a map of the physical environment is displayed. In one or embodiments, the map is overlaid with the visual representations generated in Step 216 above. Specifically, each visual representation is displayed on a location in the map that corresponds to a location of the corresponding client device in the physical environment.

In one or more embodiments, a subset of client devices are identified by the Steps 210 and 212 above. In such embodiments, visual representations (whether generated or not) of other client devices excluded from the subset are also excluded from the map.

Examples of displaying visual representations of the subset of client devices are described in reference to FIGS. 3.2 and 3.3 below. An example of displaying visual representations of all client devices located on the floor plan is described in reference to FIG. 3.1 below.

FIGS. 3.1-3.4 show examples in accordance with one or more embodiments. In one or more embodiments of the invention, the example shown in FIGS. 3.1-3.4 may be practiced using the system (100) and the method flow chart described in reference to FIG. 1 and FIG. 2, respectively. In particular, the example screenshots shown in FIGS. 3.1-3.4 may be generated by the helpdesk view generator (107x) for presenting to helpdesk users of the helpdesk (107).

FIG. 3.1 shows a screenshot A (310) of a helpdesk view showing a floor plan A (311) that is displayed to a helpdesk user. As shown in FIG. 3.1, the floor plan A (311) is overlaid with visual representations of all client devices (e.g., client device Q (101Q), client device R (101R), client device S (101S), client device T (101T) shown in FIG. 1) located on the floor plan A (311). These client device may connect to a network (e.g., network (106) shown in FIG. 1) via multiple access points (APs) (e.g., AP X (102X), AP Y (102Y) shown in FIG. 1). This helpdesk view allows the helpdesk user to visualize the client health (i.e., a particular performance measure of a client device, such as RF related performance referred to as RF health) of client devices located on (i.e., overlaying) the floor plan A (311) with a client health overlay feature. Every client device connected to the wireless network has a client health associated to it. The client health value is sent from the APs or controllers (e.g., controller (108) shown in FIG. 1) every minute and stored on a server (e.g., combination of server (109) and helpdesk (107) shown in FIG. 1) for historical trending.

Before the helpdesk user enables the client health overlay, the floor plan A (311) is overlaid with client icons (e.g., client icon (313)) representing corresponding client devices. In this mode, the visual representation of a client device includes only the client icon. When the helpdesk user enables the client health overlay, the helpdesk view generator (e.g., helpdesk view generator (107x) shown in FIG. 1) fetches the average client health for the last minute for all the client devices on the floor plan A (311). The client health is then color coded and displayed (overlaying the floor plan A (311)) as a concentric circle (e.g., concentric circle (312)) surrounding the client icon (e.g., client icon (313)) representing a corresponding client device. In this mode, the visual representation of a client device includes the client icon representing the client device and the surrounding concentric circle representing the client health. The client health is mapped to a range of colors or highlight patterns (e.g., color/highlight pattern A (314), color/highlight pattern B (315)) based on certain pre-determined percentile thresholds. For example, the color/highlight pattern B (315) may be displayed in red color or using a flashing pattern to represent an alarming client health of less than 25%. This red color or flashing pattern may be designated as an alert to the helpdesk user. Other colors (e.g., yellow, green, etc.) or other highlight patterns (e.g., cross-hatch pattern, brightness variation pattern, etc.) may also be used to represent various percentile ranges (e.g., 25%-50%, 50%-75%, 75%-100%, etc.) of client health. While there may be multiple APs on the floor plan A (310), visual representations of the APs may be turned on or off by the helpdesk user. In particular, the visual representations of the APs are turned off in the helpdesk view shown in FIG. 3.1.

When the helpdesk user selects (with the client health overlay either turned on or turned off) any particular one of the visual representations of all client devices on the floor plan A (311), the screenshot A (310) turns into the screenshot B (320) shown in FIG. 3.2 below.

FIG. 3.2 shows a screenshot B (320) of another helpdesk view showing the floor plan A (311) overlaid with visual representations of a subset (322) of all client devices located on the floor plan A (311). Specifically, the subset includes all client devices connected to a particular AP (not shown) identified by a selected client device. For example, this helpdesk view may be displayed as a result of a selection of the client device (323) by the helpdesk user. In particular, the client device (323) may be selected by the helpdesk user clicking on the corresponding visual representation overlaying the floor plan A (311). In response to this helpdesk user selection, the AP connected to the client device (323) is identified as well as all other client devices connected to this AP. This helpdesk view allows the helpdesk user to visualize the client health of any specific client device (e.g., client device (323)) and compare it to the client health of other client devices connected to the same AP. This helps the helpdesk user to understand if the RF issues are specific to the selected client device (323) or specific to the AP (or RF radio thereof) that the client device (323) is connected to. Similar to FIG. 3.1, each client device shown in FIG. 3.2 is represented by a client icon surrounded by a color coded concentric circle representing the corresponding client health.

FIG. 3.3 shows a screenshot C (330) of yet another helpdesk view showing the floor plan A (311) overlaid with visual representations of another subset (not explicitly labeled for clarity) of all client devices located on the floor plan A (311). As shown in FIG. 3.3, visual representations of the APs are turned on. Accordingly, the floor plan A (311) shown in FIG. 3.3 is additionally overlaid with visual representations (referred to as AP icons) of all APs (e.g., AP (331)) located on the floor plan A (311). Specifically, this helpdesk view is displayed as a result of a selection of the AP (331) by the helpdesk user. In particular, the AP (331) may be selected by the helpdesk user clicking on the corresponding visual representation overlaying the floor plan A (311). In response to this helpdesk user selection, all client devices connected to the selected AP (331) are identified with corresponding visual representations overlaying the floor plan A (311). The helpdesk view shown in FIG. 3.3 allows the helpdesk user to compare the health of all client devices connected to a selected AP to the client devices connected to any other AP, by simply clicking on the visual representation of any other AP and toggling back and forth between two helpdesk views. This enables the helpdesk user to understand if the client devices connected to any AP are the only ones having poor health, or if the poor health is prevalent among all client devices on the floor plan with no correlation to the APs. Similar to FIG. 3.1, each client device shown in FIG. 3.2 is represented by a client icon surrounded by a color coded concentric circle representing the corresponding client health. While the example screenshot C (330) is based on selecting a single AP, multiple APs may also be selected by clicking on multiple AP icons so that all client devices associated with these multiple selected APs are included in the visual representations of client devices.

FIG. 3.4 shows a screenshot D (340) of yet another helpdesk view showing a floor plan D (341) that is displayed to a helpdesk user. As shown in FIG. 3.4, the floor plan B (341) is overlaid with visual representations of all client devices located on the floor plan D (341). Instead of representing client health as shown in FIGS. 3.1-3.3 above, the visual representations of the client devices shown in FIG. 3.4 represent other metrics of the client devices. One example metric is application usage. By enabling an “application overlay” feature of the helpdesk, the helpdesk user may visualize the application usage for all clients on the floor plan D (341). The amount of usage per application is color coded to distinguish a client device with heavy usage of an application to other client devices with normal/acceptable usage. The helpdesk user can configure the thresholds for the color coding of the application usage. For example, concentric circle A (342) may be displayed in red color or displayed using a flashing pattern to indicate excessive application usage (i.e., usage exceeding a high usage threshold configured by the helpdesk user) of the corresponding client device. Similarly, concentric circle B (343) may be displayed in orange color or displayed using a non-flashing cross-hatch pattern to indicate high application usage (i.e., usage between the high usage threshold and a medium usage threshold configured by the helpdesk user) of the corresponding client device. Additionally, concentric circle C (344) may be displayed in green color or displayed using a different non-flashing cross-hatch pattern to indicate light application usage (i.e., usage below the medium usage threshold) of the corresponding client device. An example configuration menu is shown in TABLE 1 below where the helpdesk user has selected the usage level of application “http” to be represented using the visual representations of the client devices. In addition, the helpdesk user has selected the high usage threshold and the medium usage threshold as 100 Mb and 20 Mb, respectively. Further as shown in TABLE 1, the helpdesk user may select other applications (e.g., udp, postgres, mpi) for visualizing respective usage levels of all client devices on the floor plan D (341).

TABLE 1

Overlays

| | | | | |
|---|---|---|---|---|
| ✓ | AppRF | ▾ | | |
| | Ch. Utilizatio [symbol] | Medium Usage | 20 | M [symbol] |
| | Channel | Threshold | | |
| | Client Health | High Usage | 100 | M [symbol] |
| | | Threshold | | |
| | Heatmap | Top Ten Apps | | |

| | | |
|---|---|---|
| Speed | | 1. udp (1.81 GB) |
| UCC | ✓ | 2. http (406 MB) |
| Voice | | 3. postgres (110 MB) |

| | |
|---|---|
| Relation Line | 4. mapi (77.4 MB) |

[symbol]

indicates data missing or illegible when filed

While the visual representation of each client device described in the examples above represents client health and/or application usage in the form of a concentric circle, one skilled in the art and with the benefit of this disclosure will appreciate that other shapes or formats may also be used for the visual representation. For example, in addition to the circular shape described above, a square shape, a triangular shape, etc. may also be used. Moreover, the circular shape, the square shape, the triangular shape, etc. may be concentric, off-centric, or disposed nearby the corresponding client icon. In another example, the client health and/or application usage may be represented by a number, a percentage, or a letter grade adjacent to the corresponding client icon.

Embodiments may be implemented on virtually any type of computing system regardless of the platform being used. For example, the computing system may be one or more mobile devices (for example, laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, as shown in FIG. 4, the computing system (400) may include one or more computer processor(s) (402), associated memory (404) (for example, random access memory (RAM), cache memory, flash memory, etc.), one or more storage device(s) (406) (for example, a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (for example, a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (for example, a local area network (LAN), a wide area network (WAN) such as the Internet, mobile network, or any other type of network) via a network interface connection (not shown). The input and output device(s) may be locally or remotely (for example, via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments.

Further, one or more elements of the aforementioned computing system (400) may be located at a remote location and connected to the other elements over a network (412). Further, embodiments may be implemented on a distributed system having a plurality of nodes, where each portion may be located on a different node within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

While embodiments have been described with respect to a limited number of embodiments, those skilled in the art, having benefit of this disclosure, will appreciate that other embodiments can be devised which do not depart from the scope as disclosed herein. Accordingly, the scope should be limited only by the attached claims.

What is claimed is:

1. A non-transitory computer readable medium comprising instructions which, when executed by one or more hardware processors, causes performance of:
obtaining a performance measurement and a physical location for each of a plurality of client devices;
generating a plurality of visual representations corresponding to the plurality of client devices by: for each client device, of the plurality of client devices, generating a corresponding visual representation based on a respective performance measurement for that client device; and
displaying a map of a physical environment with the plurality of visual representations, wherein each visual representation is displayed on a location in the map that corresponds to a location of the corresponding client device.

2. The non-transitory computer readable medium of claim 1, wherein the instructions, when executed by the one or more hardware processors, further causes performance of:
selecting a subset of visual representations, of the plurality of visual representations, that correspond to client devices associated with a particular set of one or more access points; and
displaying the map with the subset of visual representations without displaying other visual representations in the plurality of visual representations.

3. The non-transitory computer readable medium of claim 1, wherein a color used within each visual representation indicates the respective performance measurement for the corresponding client device.

4. The non-transitory computer readable medium of claim 1, wherein the performance measurement is based on actual time used by a client device to transmit a particular amount of data.

5. The non-transitory computer readable medium of claim 1, wherein the performance measurement is based on actual time used by a client device to transmit a particular amount of data and a target time used by the client device to transmit the particular amount of data.

6. The non-transitory computer readable medium of claim 1, wherein the performance measurement comprises at least one selected from a group consisting of a number, a percentage, and a letter grade.

7. The non-transitory computer readable medium of claim 2, wherein the instructions, when executed by the one or more hardware processors, further causes performance of:
displaying a plurality of access point icons comprising one or more access point icons representing the particular set of one or more access points; and
receiving a user selection of the one or more access point icons,
wherein selecting the subset of visual representations that correspond to client devices associated with the particular set of one or more access points is in response to receiving the user selection of the one or more access point icons.

8. A non-transitory computer readable medium comprising instructions which, when executed by one or more hardware processors, causes performance of:
receiving a request for a performance measurement of a particular client device of a plurality of client devices;
identifying an access point with which the particular client device is associated;
identifying a plurality of client devices associated with the access point;
displaying a performance measurement for each of the plurality of client devices including the particular client device.

9. The non-transitory computer readable medium of claim 8, wherein the displaying operation comprises displaying a visual representation of each of the plurality of client devices on a map, wherein each visual representation for a client device is displayed on the map at a location corresponding to a location of the client device in a physical environment.

10. The non-transitory computer readable medium of claim 8, wherein a color used within each visual representation indicates the respective performance measurement for the corresponding client device.

11. The non-transitory computer readable medium of claim 8, wherein the performance measurement is based on actual time used by a client device to transmit a particular amount of data.

12. The non-transitory computer readable medium of claim 8, wherein the performance measurement is based on actual time used by a client device to transmit a particular amount of data and a target time used by the client device to transmit the particular amount of data.

13. The non-transitory computer readable medium of claim 8, wherein the performance measurement comprises at least one selected from a group consisting of a number, a percentage, and a letter grade.

14. A non-transitory computer readable medium comprising instructions which, when executed by one or more hardware processors, causes performance of:
obtaining data indicating usage of one or more applications by each of a plurality of client devices;
generating a plurality of visual representations corresponding to the plurality of client devices by: for each client device, of the plurality of client devices, generating a corresponding visual representation based on the usage of the one or more applications by the client device;
displaying a map of a physical environment with the plurality of visual representation, wherein each visual representation is displayed on a location in the map that corresponds to a location of a corresponding client device.

15. The non-transitory computer readable medium of claim 14, wherein the instructions, when executed by the one or more hardware processors, further causes performance of:
selecting a subset of visual representations, of the plurality of visual representations, that correspond to client devices associated with a particular set of one or more access points; and
displaying the map with the subset of visual representations without displaying other visual representations in the plurality of visual representations.

16. The non-transitory computer readable medium of claim 15, wherein the instructions, when executed by the one or more hardware processors, further causes performance of:
displaying a plurality of access point icons comprising one or more access point icons representing the particular set of one or more access points; and
receiving a user selection of the one or more access point icons,
wherein selecting the subset of visual representations that correspond to client devices associated with the particular set of one or more access points is in response to receiving the user selection of the one or more access point icons.

17. The non-transitory computer readable medium of claim 14, wherein a color used within each visual representation indicates the respective usage of the one or more application for the corresponding client device.

18. The non-transitory computer readable medium of claim 14, wherein the usage of the one or more application is based on an actual amount of data transmitted by the one or more application.

19. The non-transitory computer readable medium of claim 14, wherein the usage of the one or more application is based on an actual amount of data transmitted by the one or more application and a target amount of data transmitted by the one or more application.

20. The non-transitory computer readable medium of claim 14, wherein the usage of the one or more application comprises at least one selected from a group consisting of a number, a percentage, and a letter grade.
